(19) United States
(12) Patent Application Publication
(10) Pub. No.: US 2021/0110476 A1
(43) Pub. Date: Apr. 15, 2021

(54) Real-Time Financial and Performance Sports Index Platform using Artificial Intelligence for Professional Athletes and Teams

(71) Applicant: Joshua Farshid Ebrahim, Brooklyn, NY (US)

(72) Inventor: Joshua Farshid Ebrahim, Brooklyn, NY (US)

(21) Appl. No.: 17/006,822

(22) Filed: Aug. 29, 2020

Related U.S. Application Data
(60) Provisional application No. 62/888,630, filed on Aug. 19, 2019.

(51) Int. Cl. G06Q 40/06; G06Q 50/18; G06Q 10/10; G06Q 10/06; G06N 20/00; G06F 16/22

(52) U.S. Cl. CPC G06Q 40/06; G06Q 50/18; G06F 16/2228; G06Q 10/06398; G06N 20/00; G06Q 10/10

(57) ABSTRACT

A Financial and Performance Index system and process using artificial intelligence giving professional athletes and sport teams a measured real-time professional athlete contract value derived from machine learning algorithms that use historical and current performance data to monitor and project insights on current and future trajectory of professional athlete performance and development, team financials, contract negotiations, professional team placement, career development, professional team roster acquisition transactions. The system and process of the present disclosure that delivers transparency and balance with real-time financial and performance insights of professional athletes and teams throughout the season, previous seasons, and future seasons that they use to enhance the decision making process.

### CROSS-REFERENCE TO RELATED APPLICATIONS

The present application claims the priority of the U.S. provisional patent application No. 62/888,630 filed on Aug. 19, 2019.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present disclosure relates to the field of systems for financial and performance evaluation, and more particularly to a system and process for measuring professional athlete contracts using artificial intelligence to monitor the real-time trajectory of professional athlete contract value, professional athlete performance, and professional athlete career development.

### Description of the Related Art

Professional athletes are forced to use outdated financial and performance data that does not accurately represent the professional athlete in real-time when they enter contract extensions/free agency and for performance development which favors the professional teams to offer undervalued professional team contracts to professional athletes with no contract flexibility on renegotiating those terms in the future if the professional athlete outperforms his current professional team contract. This will benefit the professional athlete to understand when he is overvalued or undervalued on his current professional team contract and understand the performance drivers valued and sought after by professional teams, the trajectory of the professional athlete's development, how the professional athlete fits with the professional team performance style, the professional athlete's current career potential, and professional athlete's performance during his career and current season that are aligned with their current professional team and the rest of the professional teams that may potentially want to acquire his services in the future.

Professional teams perform a flurry of complicated roster transactions such as trades, terminating professional athlete contracts, and professional athlete contract extensions throughout the year that requires in-depth real-time professional athlete performance and financial analysis to accurately assess professional athletes. Professional teams need to accurately monitor appropriate professional athlete development and real-time performance and financial valuation metrics that are cross-referenced with their own current professional team to accurately value a professional athlete and decide on his impact and if they deem it a good fit both financially and performance wise with the professional team.

Parity, transparency, and reliable, up-to-date data, are paramount when dealing with high stakes decisions that affect the trajectory of professional athlete's lives and the professional team's bottom line. When professional athletes and teams enter free agency and contract extensions, there is no industry standard that allows professional athlete's to know their current market value, projected professional team contract offer, and which professional team is the best fit both financially and performance wise and understand why the professional team needs to sign the professional athlete. If the professional athlete understands the need for his services and his real-time contract value in conjunction with all available professional teams, the professional athlete will have more leverage to find the ideal situation best suited for his career. Professional athletes have argued that professional teams have too much of the power, offering below value professional team contracts with the flexibility to terminate the professional athlete contract at will, do not utilize the professional athlete's performance strengths within the professional team system, and not developing the professional athlete to reach his full potential.

Professional teams must identify professional athletes that are undervalued and that can overperform within their professional team system and put their best foot forward to develop and sign professional athletes to contracts that match their financial value and potential. This will prevent professional teams from overpaying financially and enhance the ability to be competitive from a performance perspective. Professional teams will become more of a destination if they develop a reputation of professional athlete development, taking care of their current professional athletes under contract financially, and competing for professional team championships on a regular basis.

When there is transparency within the metrics and real-time data that professional teams place value on, professional athletes will have a better understanding at what value they bring to a professional team in the short and long term throughout their career.

Professional teams have a multi-year window where they can compete for a championship and can maintain that competitive status through precise financial planning, professional athlete development, accumulating professional athlete assets to exchange with other professional teams, and professional athlete acquisitions that allow professional teams to build their roster with top professional athletes and compliment their skillset with professional athletes under contract providing strength/depth to the professional team roster with over performing and undervalued professional athlete contracts during that window.

Professional teams and athletes will now have the ability to evaluate multiple operational scenarios through artificial intelligence in professional athlete contract extensions, free agency contract projections, professional team financial planning, professional team transactions, athlete performance development, and professional team roster decisions.

### SUMMARY OF THE INVENTION

In an aspect, the present disclosure is a system and process for measuring and monitoring professional athlete contracts and performance using artificial intelligence to monitor the trajectory of professional athlete real-time contract value, professional athlete performance attributes, and professional athlete career development.

In another aspect, the present disclosure comprising of a professional team index and professional athlete index that consists of athlete listings, athlete DNA, athlete roles, star system reliance, position versatility, tendencies, attributes, athlete synergy, career outlook, injury risk/load management, opportunity, proXtial, team fit, professional athlete performance, trade assets, athlete contracts; and performance.

In yet another aspect, the present disclosure provides parity and balance to professional athletes and professional teams for them to be able to find the financial and performance fit for both professional teams and athletes that ensures that both sides will get the most out of their working relationship.

In yet another aspect, the system and process of the present disclosure using professional athlete and professional team real-time data in a machine learning mixed method linear regression algorithm to create a real-time contract value for the professional athletes.

In yet another aspect, the system and process of the present disclosure are to give professional teams on professional athlete's real-time financial insights based off of their performance throughout the season, previous seasons, and future seasons.

In yet another aspect, the system and process of the present disclosure are to identify style of play through professional athlete performance, projections of professional athlete performance and financials, and the ability to visually monitor the trajectory of the professional athlete with financial and performance based metrics that affect professional athlete performance development with injuries and professional teams that are not suited to professional athlete's playing style.

In yet another aspect, the system and process of the present disclosure help if the professional athlete is under performing or over performing on his current professional team contract, it will mitigate the long-term risk and enhance professional team competitiveness with investing in professional athlete contracts both short and long term knowing the volatility of their real-time contract value and professional athlete performance development that are integrated with the professional sports team index.

In yet another aspect, the system and process of the present disclosure includes two sections using the same concepts, a professional team index and professional athlete index.

In yet another aspect, the system and process of the present disclosure consolidated professional team index using artificial intelligence and collecting historical and real-time data on professional athletes for a professional team to use in future professional team transactions of professional athletes and maintaining optimal professional team performance metrics that professional teams' value within their performance system.

In yet another aspect, the system and process of the present disclosure using real-time insights for a professional athlete's performance development trajectory and in-season performance and integrate that with financial valuation metrics that fully maximize the potential of a professional athlete.

### BRIEF DESCRIPTION OF DRAWINGS

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 illustrates a flow chart showing the professional athlete and professional team sections of the process and system;

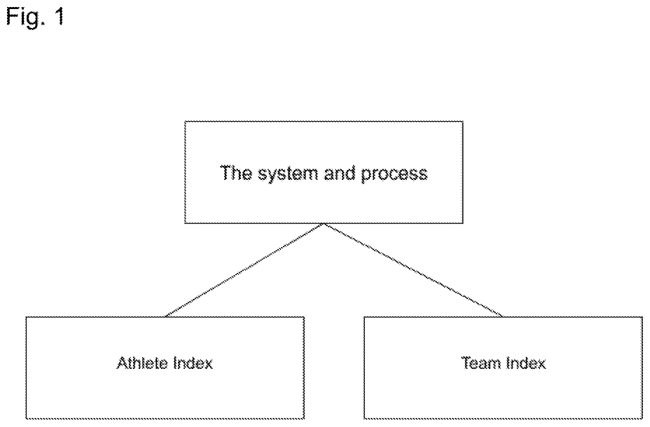

FIG. 2 illustrates a flowchart showing the modules of the professional athlete index section; and,

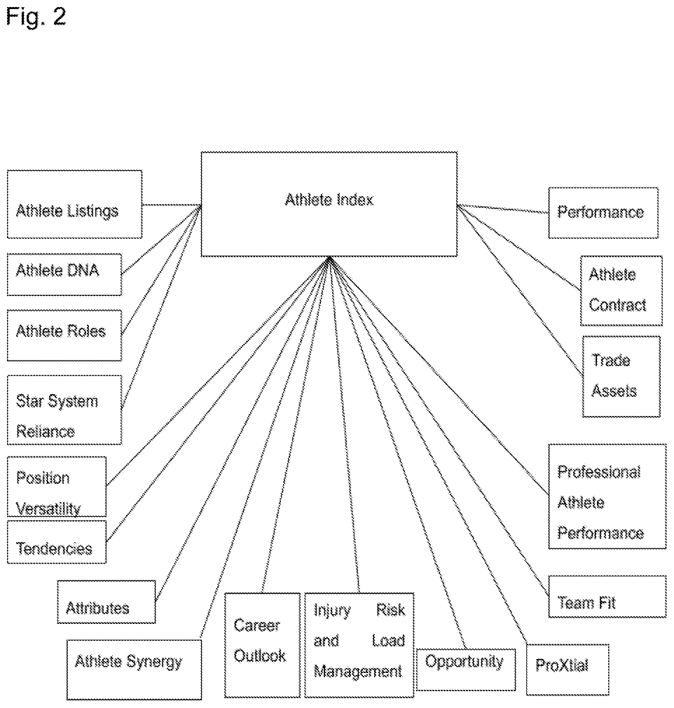

FIG. 3 illustrates a flowchart showing the modules of the professional team index section;

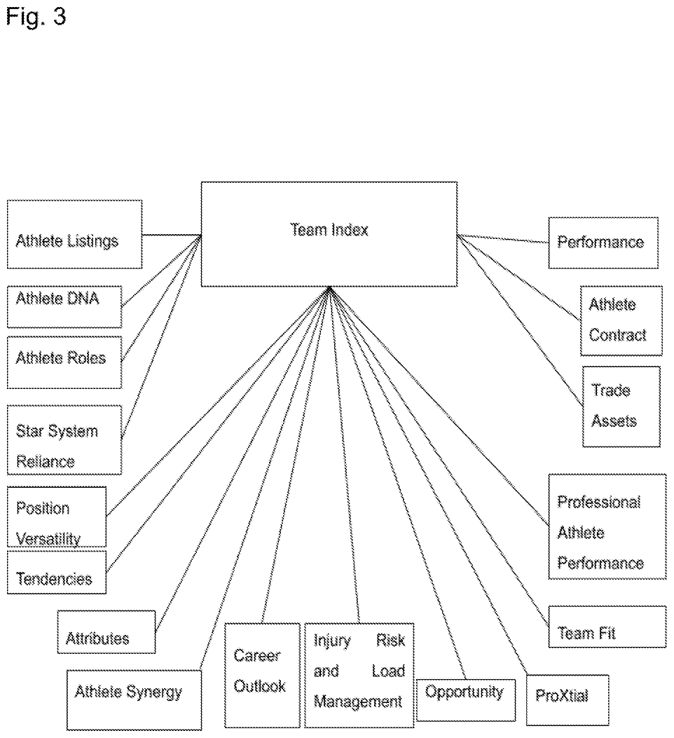

It should be noted that the accompanying figures are intended to present illustrations of few exemplary embodiments of the present disclosure. These figures are not intended to limit the scope of the present disclosure. It should also be noted that accompanying figures are not necessarily drawn to scale.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to elements throughout, and thicknesses and dimensions of some components may be exaggerated for providing better clarity and ease of understanding.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced items.

The following definitions are to help understanding the present disclosure:

Contract Extension: Allows a professional team to extend the years and increase or decrease the dollar amount of a professional athlete's current contract.
Free Agency: Allows a professional athlete that has an expired professional team contract to seek a new professional team and contract.
Professional Athlete Development: Areas of performance and the ability to visually track the trajectory of the professional athlete's performance and whether he is performing at a high level or low level.
Professional Team System & Fit: Ability to identify if a professional athlete's performance style is in sync with how the professional team performs and caters to the individual professional athlete's performance style.
Professional Athlete Assets: Defined when a professional athlete is performing at a high-performance level and other professional teams place a high value on that particular professional athlete that requires planning and strategy in order to acquire his services.
Professional Athlete Transactions: Occurs when a professional team attempts to acquire the services of this professional athlete through a professional athlete exchange or free agency.
Professional Team Financial Planning: Professional team's strategy of acquiring professional athletes with a professional team contract under specific financial restrictions that the professional team faces in order to stay profitable and competitive at the same time

The present disclosure is a system and process using real-time professional athlete and team insights in a machine learning mixed method linear regression algorithm to create a real-time contract value for the professional athletes. From this algorithm, there are artificial intelligence insights for professional teams and athletes such as professional athlete valuation, professional team transactions, professional team asset management, free agency, contract negotiations, and professional athlete performance development and matching with both individual professional athletes and team.

This platform provides parity and balance to both sides to understand what drivers for both professional athletes and teams to ensure that both sides will get the most out of their working relationship. The value placed on this platform is the ease of critical real-time artificial intelligence decisions being deciphered to reinforce a professional team's decision on acquiring a professional athlete through free agency, trade, or resigning a professional athlete to a contract extension that is calibrated to fully optimize the best situation for both professional team and athlete.

The system and process of the present disclosure are to give professional teams insights on professional athlete's real-time financial information based off of their performance throughout the season, previous seasons, and future seasons. It will identify style of play through his performance and the ability to visually monitor the trajectory of the professional athlete both financially and performance based that hinder his performance development with injuries and professional teams that are not suited to his playing style.

In the present disclosure, if the professional athlete is under performing or over performing his current professional team contract. It will mitigate the long-term risk and enhance team competitiveness with investing in professional athlete contracts both short and long term knowing the volatility of their real-time contract value and professional athlete performance development that are integrated with the professional team index.

The machine learning algorithms would need to be reversed engineered with the specific inputs and ranges. For the application, the professional team and athlete indexes will require a very deep understanding of the collective bargaining agreement for that respective sport and high-level professional team management experience. All of the components of the application can be shuffled, interchanged, or reconfigured to produce different functions. The weights and indexes are variable depending on the specific set of data.

Basically, the system of the present disclosure includes two sections that will use the same concepts for professional athletes and teams. In the following parts, we will explain in detail every section that will use the same concepts for professional athletes and teams.

Sport Team Index—Consolidated professional team index using artificial intelligence and collecting historical and real-time data on professional athletes and areas of a professional team to use in future professional team transactions of professional athletes and maintaining optimal professional team performance metrics that professional teams' value within their performance system.
Professional Athlete Index—Artificial intelligence platform for professional athletes that provide real-time insights for a professional athlete's performance development trajectory and in-season performance and integrate with financial valuation metrics that fully maximize the potential of a professional athlete.

### Athlete & Team

Athlete Listings—This page lists all the active professional athletes under the designated professional league for that respective sport in a searchable format. It provides the user with an overview of any professional athlete within the index. It includes key performance drivers for the current season, their real-time contract value for the current season, their designated performance roles for offense and defense for the current season, professional athlete versatility for offense and defense, and a real time financial contract projection trajectory percentage on the professional athlete's next contract when he reaches free agency in the next 5 years.

Athlete DNA—A breakdown of all the professional athlete's individual blueprint for identifying performance areas and habits that are used to evaluate each professional athlete and how they are best utilized within a professional team. This will show the designated type of professional athlete's performance roles and ratings for throughout the current season and his entire career. It will also identify the movement and effectiveness of the professional athlete's performance and which professional athletes are best suited to perform at a high-performance level with this particular athlete individually or is depending on the playing style of his current and previous professional teams.

Athlete Roles—This defines the professional athlete's individual performance style on Offense and Defense. It is broken down into 12 roles that reflect on the particular sports. These names are uniquely invented to match their activity in the game. It will identify the real time and historical top 4 professional athlete roles and ratings and also show the trajectory of areas where the professional athlete can improve upon to be designated a different role and bring more value to himself financially and to the team.

Star System Reliance—This shows the professional athlete's reliance on the professional teams that he has played for throughout his career and shows whether his performance production and playing style are reliant on the professional team playing style or if he consistently performs at a high level regardless of what professional team he plays for. This will show how talented the professional athlete is and the variation of his overall performance as he changes professional teams throughout his career. This is used for professional teams when offering contracts to understand if the professional athlete will continue to perform at a high level or if his production will decrease because of the particular playing style of his previous professional teams.

Position Versatility—This model shows where the professional athlete is performing at a high level in conjunction with location and where he is strong and weak in areas of performance, efficiency, and frequency on the playing field.

Tendencies—This model shows the historical and current trajectory of the individual professional athlete's individual performance tendencies and identify areas of development for the user to visually see the progress throughout the season and historically in a time series chart.

Attributes—This model shows the historical and current trajectory of the individual professional athlete's individual performance attributes and identifies areas of development for the user to visually see the progress throughout the season and historically in a time series chart.

Athlete Synergy—Identifies which individual professional athletes are poised to be a “perfect” fit performance with the designated professional athlete in 1 and 2 professional athlete combinations based off of professional athlete performance roles and ratings, professional athlete performance, real time professional athlete contract value, professional athlete contract expiration year, and ideal professional team/system fit both financially and performance based.

### Impact Pillar Ratings

Career Outlook—Feature maps out the trajectory of a professional athlete beginning their first year into the years the professional athlete has played that will subsequently follow in performance and financial metrics. It will identify what stage the professional athlete is currently performing at during his career, the professional athlete age trajectory on his performance and if the professional athlete is getting better with age or decreasing with his performance as he gets older, the year the professional athlete's real time and current professional athlete contract amount, contract expiration and free agency year along with the projected professional athlete contract earnings suggested for his next professional team contract.

Injury Risk and Load Management—Feature involves the current injury risk rating and historical injury information leading to the impact of whether a professional athlete should rest or play, duration, and apply a minute's restriction to play on for the professional athlete. Will also display season professional athlete was injured, body part effected, intensity of injury to the part, the type of injuries, length of injury, days missed, treatment for injury, and recovery time per injury, an overview of financial impact his injuries have on his real time and projected professional athlete contract, number of surgeries during his career, and average of games missed per season.

Opportunity—Feature indicated where there is a chance to improve a particular performance areas in a professional athlete's games throughout the season and identify when the professional athlete should be playing based on a surge in his performance throughout the current season and identified as a hidden gem when a professional athlete is overperforming and being underutilized by his professional team. Will also have a feature where you can manually enter the number of minutes for the next 5 games and see what the projected professional athlete performance will be.

ProXtial—Named similar to the word ‘Potential’ to reflect the importance of the features. ProXtial is going to identify the top 3 ratings of the professional athlete's performance, that is he is developing in offensive and defensive performance areas and show the trajectory of the top professional athlete performance categories for the current season.

Team Fit—To demonstrate the professional athlete's current and historical professional team fit and top 5 professional team fits based on professional athlete performance indicators of professional athlete performance style and professional team performance and identifying the best match for both parties.

Professional Athlete Performance—This will show the overall performance rating in a time series format and to track and visually see professional athlete performance trajectory for the current season and previous 4 years.

Trade Assets—The feature allows users to compare assets that other professional teams hold with their own in order to highlight undervalued/overvalued trades.

athlete Contract—Feature allows the user to view a professional athlete's contract in a visual graph that also includes points within the professional athlete's contract history which impacts the trajectory of the professional athlete's projected contract offer when he reaches his contract expiration. Users will be able to see the events as well as impact to the current professional athlete contract. This page will include several features within the model that display different types of information regarding the financial value of the professional athlete within the model. It will show what the professional athlete's projected contract value is when he becomes a free agent and what the terms of the professional athlete contract should be when he reaches that expiration year and whether he should test the free agent market or resign with his current professional team. It will also show when the professional athlete is underperforming on a high professional team contract given by his current professional team. This model will breakdown the professional athlete's production per dollar, current professional team contract advantage, and identify whether the professional athlete is an investment risk to his professional team.

Performance—This model will show the professional athlete performance into two categories. One displaying the breakdown of the financial impact of the professional athlete's performance attributes into individual financial breakdowns and applying a financial value to each of those attributes. Performance Impact will the value of professional athlete's performance compared towards the overall current team performance and the importance of how vital that professional athlete is to their current professional team.

Real Time Contract Value—A new approach invented to analyze the professional athlete's historical data of their performance and salaries. The AI algorithm is built to project the professional athlete's real time contract value to better assess the professional athlete's performance is on par with the salary that is being paid. This will also help the professional team management to assess whether the professional athlete's performance is either over or under the expected levels. The innovative algorithm can also project the performance for forthcoming seasons.

### Athlete DNA

athlete Roles—A new approach invented to analyze the professional athlete's historical data about their performance style in both Offense and Defense. 12 types of athlete roles invented, and AI logic will provide the ranking for each type of professional athlete role based on their historical data. The logic followed for assessing the performance for each role is unique and first of its kind.

Star System Reliance—A new approach invented to analyze the professional athlete's entire career data and determine if a professional athlete's performance is reliant on the professional team or if the athlete's performance is consistent regardless of what professional team he plays for.

Position Versatility—A new approach invented to analyze the professional athlete's historical data and determine where the professional athlete's is performing at a high level in conjunction with location in the court. This will also help identify the strong and weak areas in the court.

Tendencies—A new approach invented to analyze the professional athlete's historical data and determines the professional athlete's individual playing tendencies and trajectory of development. This will be a time series model where users can analyze professional athlete's historical versatility.

Attributes—A new approach invented to analyze the professional athlete's historical data and determines the professional athlete's individual playing attributes and trajectory of development. This will be a time series model where users can analyze professional athlete's historical versatility.

Athlete Synergy—A new approach invented to analyze the professional athlete's historical data and determine the professional athletes from the other professional teams in that sport compliment the individual professional athlete from a performance and financial perspective. Identifies which professional athletes are poised to be a “perfect” fit for each other, performance wise, monetarily as well as ideal team/system.

### Impact Pillar Ratings

Career Outlook—A new approach invented to analyze the professional athlete's historical data and determine the trajectory of a professional athlete beginning their rookie year into the years that will subsequently follow. An overall outlook of the professional athlete will be shown visually on how he has professionally grown from their rookie year till the current state.

Injury Risk—A new approach invented to analyze the professional athlete's historical injuries data and determine how often a professional athlete is prone to injury and the percentage of injury risk involved.

Load Management—This model involves determining professional athlete playing minutes load based on the current stats and the historical stats and determines whether a professional athlete should rest or play, and for how long.

Opportunity—A new approach invented to analyze the professional athlete's historical data and suggest the best suitable length of the professional athlete for the next 5 matches.

ProXtial—A new approach invented to analyze the professional athlete's historical data and determine the areas of the professional athlete's performance that he is developing in and show the trajectory of the top performance categories from season to season. The artificial intelligence algorithm is built to predict the performance metrics for the 2 seasons to come.

Team Fit—A new approach invented to analyze the professional athlete's historical data and determine the best 5 professional teams the professional athlete can fit in based on performance and financial indicators.

Athlete Performance—A new approach invented to analyze the professional athlete's historical data and determines professional athlete's performance for the selected stats.

Trade Assets—A new approach invented to analyze the professional athlete's historical data and provides an option to the user to compare professional athletes that other professional teams hold with their own to highlight undervalued/overvalued trades.

Athlete Contract—A new approach invented to analyze the professional athlete's historical data and provides an option to the user to view a professional athlete's contract visually that also includes points within the professional athlete contract history which impacted the trajectory of the professional athlete contract. Users will be able to see the event as well as impact to the current contract.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Although the present disclosure has been explained in relation to its preferred embodiment(s) as mentioned above, it is to be understood that many other possible modifications and variations can be made without departing from the spirit and scope of the inventive aspects of the present invention. It is, therefore, contemplated that the appended claim or claims will cover such modifications and variations that fall within the true scope of the invention.

What is claimed is:

1. A system and process for measuring professional athlete contracts using artificial Intelligence to monitor the trajectory of professional athlete real-time contract value, performance attributes, and career development, comprising:
a professional sport team Index and athlete Index comprising the modules of:
athlete listings;
athlete DNA;
athlete roles;
star system reliance;
position versatility;
tendencies;
attributes;
athlete synergy;
career outlook;
injury risk and load management;
opportunity;
proxtial;
sport team fit;
professional athlete performance;
trade assets;
athlete contract; and,
performance.

2. The system and process of claim 1 provides parity and balance to professional athletes and sport teams to understand what performance and financial drivers for both professional athletes and sport teams to find the right fit for both professional teams and athletes to ensure that both sides will get the most out of their working relationship.

3. The system and process of claim 1 using real-time professional athlete and sports team data in a machine learning mixed method linear regression algorithm to create a real-time contract value for the professional athletes.

4. The system and process of claim 1 are to give professional teams insights on professional athletes real-time financial information based off of their performance throughout the season, previous seasons, and future seasons.

5. The system and process of claim 1 are to identify style of play through professional athlete performance, projections of performance and financials and the ability to visually track the trajectory of the professional athlete both financially and performance based and areas that hinder his development with injuries and professional teams that are not suited to his playing style.

6. The system and process of claim 1 wherein if the professional athlete is under performing or over performing his current professional team contract, It will mitigate the long-term risk and enhance team competitiveness with investing in professional athlete contracts both short and long term knowing the volatility of their real-time contract value and professional athlete performance development that are integrated with the professional sports team index.

7. The system and process of claim 1 includes two sections using the same concepts, a professional sport team index and athlete index.

8. The professional team index of claim 1 consolidated professional team index using artificial intelligence and collecting historical and real-time data on professional athletes and areas of a professional team to use in future professional team transactions of professional athletes and maintaining optimal professional team performance metrics that professional teams value within their performance system.

9. The professional athlete index of claim 1 using artificial intelligence platform for professional athletes in all sports across the world that provide real-time insights for a professional athlete's performance development trajectory and in season performance and integrate that with financial valuation metrics fully maximize the potential of a professional athlete.

10. The athlete listings module of claim 1 wherein this page lists all the active professional athletes under the designated professional league for that respective sport in a searchable format, the athlete listings provides the user with an overview of any professional athlete within the index, the athlete listings includes key performance drivers for the current season, their real-time contract value for the current season, their designated performance roles for offense and defense for the current season, professional athlete versatility for offense and defense, and a real-time financial contract projection trajectory percentage on the professional athlete's next contract when he reaches free agency in the next 5 years.

11. The athlete DNA module of claim 1 is a breakdown of all the professional athlete's individual blueprint for identifying performance areas and habits that are used to evaluate each professional athlete and how they are best utilized within a professional team, the athlete DNA shows the designated type of professional athlete's performance roles and ratings for throughout the current season and his entire career, the athlete DNA identify the movement and effectiveness of the professional athlete's performance and which professional athletes are best suited to perform at a high-performance level with this particular athlete individually or is depending on the playing style of his current and previous professional teams.

12. The athlete roles module of claim 1 defines the professional athlete's individual performance style on offense and defense, the athlete roles is broken down into 12 roles that reflect on the particular sports, the athlete roles are to match their activity in the game, the athlete roles identify the real-time and historical top 4 professional athlete roles and ratings and also show the trajectory of areas where the professional athlete can improve upon to be designated a different role and bring more value to himself financially and to the team.

13. The star system reliance module of claim 1 shows the professional athlete's reliance on the professional teams that he has played for throughout his career and shows whether his performance production and playing style are reliant on the professional team playing style or if he consistently performs at a high level regardless of what professional team he plays for, the star system shows how talented the professional athlete is and the variation of his overall performance as he changes professional teams throughout his career, the star system is used for professional teams when offering contracts to understand if the professional athlete will continue to perform at a high level or if his production will decrease because of the particular playing style of his previous professional teams.

14. The position versatility module of claim 1 shows where the professional athlete is performing at a high level in conjunction with location and where he is strong and weak in areas of performance, efficiency, and frequency on the playing field.

15. The tendencies module of claim 1 shows the historical and current trajectory of the individual professional athlete's individual performance tendencies and identifies areas of development for the user to visually see the progress throughout the season and historically in a time series chart.

16. The attributes module of claim 1 shows the historical and current trajectory of the individual professional athlete's individual performance attributes and identifies areas of development for the user to visually see the progress throughout the season and historically in a time series chart.

17. The athlete synergy module of claim 1 Identifies which individual professional athletes are poised to be a perfect fit performance with the designated professional athlete in 1 and 2 professional athlete combinations based off of professional athlete performance roles and ratings, professional athlete performance, real-time professional athlete contract value, professional athlete contract expiration year, and ideal professional team/system fit both financially and performance based.

18. The career outlook module of claim 1 features maps out the trajectory of a professional athlete beginning their first year into the years the professional athlete has played that will subsequently follow in performance and financial metrics, the career outlook will identify what stage the professional athlete is currently performing at during his career, the professional athlete age trajectory on his performance and if the professional athlete is getting better with age or decreasing with his performance as he gets older, the year the professional athlete's real time and current professional athlete contract amount, contract expiration and free agency year along with the projected professional athlete contract earnings suggested for his next professional team contract.

19. The injury risk and load management module of claim 1 features involves the current injury risk rating and historical injury information leading to the impact of whether a professional athlete should rest or play, duration, and apply a minute's restriction to play on for the professional athlete while displaying season professional athlete was injured, body part effected, intensity of injury to the part, the type of injuries, length of injury, days missed, treatment for injury, and recovery time per injury, an overview of financial impact his injuries have on his real-time and projected professional athlete contract, number of surgeries during his career, and average of games missed per season.

20. The opportunity module of claim 1 wherein there is a chance to improve a particular performance areas in a professional athlete's games throughout the season and identify when the professional athlete should be playing based on a surge in his performance throughout the current season and identified as a hidden gem when a professional athlete is overperforming and being underutilized by his professional team.

21. The opportunity module of claim 1 wherein a user can manually enter the number of minutes for the next 5 games and see what the projected professional athlete performance will be.

22. The proxtial module of claim 1 named similar to the word ‘potential’ to reflect the importance of the features wherein the proxtial is going to identify the top 3 ratings of the professional athlete's performance, that is he is developing in offensive and defensive performance areas and show the trajectory of the top professional athlete performance categories for the current season.

23. The team fit module of claim 1 is to demonstrate the professional athlete's current and historical professional team fit and top 5 professional team fits based on professional athlete performance indicators of professional athlete performance style and professional team performance and identifying the best match for both parties.

24. The professional athlete performance module of claim 1 shows the overall performance rating in a time series format and to track and visually see professional athlete performance trajectory for the current season and previous 4 years.

25. The trade assets module of claim 1 allows users to compare assets that other professional teams hold with their own in order to highlight undervalued/overvalued trades.

26. The athlete contract module of claim 1 allows the user to view a professional athlete's contract in a visual graph that also includes points within the professional athlete's contract history which impacts the trajectory of the professional athlete's projected contract offer when he reaches his contract expiration, users are able to see the events as well as impact to the current professional athlete contract, wherein this page will include several features within the model that display different types of information regarding the financial value of the professional athlete within the model, the athlete contract shows what the professional athlete's projected contract value is when he becomes a free agent and what the terms of the professional athlete contract should be when he reaches that expiration year and whether he should test the free agent market or resign with his current professional team, the athlete contract shows when the professional athlete is underperforming on an over-valued professional team contract given by his current professional team, the athlete contract breakdown the professional athlete's production per dollar, current professional team contract advantage, and identify whether the professional athlete is an investment risk to his professional team.

27. The performance module of claim 1 shows the professional athlete performance into two categories, the first category displaying the breakdown of the financial impact of the professional athlete's performance attributes into individual financial breakdowns and applying a financial value to each of those attributes, and the second category displaying performance Impact will be the value of professional athlete's performance compared towards the overall current team performance and the importance of how vital that professional athlete is to their current professional team.

28. The system and process of claim 1 use algorithms and artificial intelligence insights for professional teams and athletes.

29. The algorithm of claim 1 is reversed engineered with the specific inputs and ranges, for the application, the professional team and athlete indexes require a very deep understanding of the collective bargaining agreement for that respective sport and high-level team management experience, all of the components of the application can be shuffled, interchanged, or reconfigured to produce different functions, the weights and indexes are variable depending on the specific set of data.

30. The system and process of claim 1 is to analyze the professional athlete's historical data of their performance and salaries, wherein the artificial intelligence algorithm of claim 1 projects the professional athlete's real-time contract value to better assess the professional athlete's performance is on par with the salary that is being paid and will help the professional team management to assess whether the professional athlete's performance is either over or under the expected levels, and the algorithm projects the performance for forthcoming seasons.

31. The athlete roles module of claim 1 and claim 12 is to analyze the professional athlete's historical data about their playing style in both offense and defense, the athlete roles includes 12 types, and AI logic will provide the ranking for each type of professional athlete role based on their historical data, the logic followed for assessing the performance for each role is unique and first of its kind.

32. The star system reliance module of claim 1 and claim 13 is to analyze the professional athlete's entire career data and determine if the professional athlete's performance is reliant on the professional team or if the professional athlete's performance is consistent regardless of what professional team he plays for.

33. The position versatility module of claim 1 and claim 14 is to analyze the professional athlete historical data and determine where the professional athlete is performing at a high level in conjunction with location in the court to help identify the strong and weak areas in the court.

34. The tendencies module of claim 1 and claim 15 is to analyze the professional athlete historical data and determine the professional athlete's individual playing tendencies and trajectory of development to make users can analyze athletes historical versatility.

35. The attributes module of claim 1 and claim 16 is to analyze the professional athlete historical data and determine the professional athlete's individual playing attributes and trajectory of development to make users can analyze athletes historical versatility.

36. The athlete synergy module of claim 1 and claim 17 is to analyze the athletes historical data and determine the athletes from the other professional teams in that sport compliment the professional athlete from a performance and financial perspective to identify which professional athletes are poised to be a “perfect” fit for each other, performance wise, monetarily as well as ideal team/system.

37. The career outlook module of claim 1 and claim 18 is to analyze the professional athletes historical data and determine the trajectory of a professional athlete beginning their rookie year into the years that will subsequently follow, an overall outlook of the professional athlete will be shown visually on how he has professionally grown from their rookie year till the current state.

38. The injury risk module of claim 1 and claim 19 is to analyze the professional athletes historical injury data and determine how much a professional athlete is prone to injury and the percentage of injury risk involved.

39. The load management module of claim 1 and claim 19 involves determining a professional athlete's minutes load based on the current stats and the historical stats and determines whether a professional athlete should rest or play, and for how long.

40. The opportunity module of claim 1, claim 20 and claim 21 is to analyze the athletes historical data and suggest the best suitable length of the athlete for next 5 matches.

41. The proxtial module of claim 1 and claim 22 is to analyze the professional athlete's historical data and determine the areas of the professional athlete's performance that he is developing in and show the trajectory of the top performance categories from season to season, the AI algorithm of claim 1 is built to predict the performance metrics for the 2 seasons to come.

42. The team fit module of claim 1 and claim 23 is to analyze the professional athlete's historical data and determine the best 5 professional teams the professional athlete can fit in based on performance and financial indicators.

43. The athlete performance module of claim 1 and claim 24 is to analyze the professional athlete's historical data and determine performance for the selected stats.

44. The trade assets module of claim 1 and claim 25 is to analyze the professional athlete's historical data and provides an option to the user to compare professional athletes that other teams hold with their own to highlight undervalued/overvalued trades.

45. The athlete contract module of claim 1 and claim 26 is to analyze the professional athletes historical data and provides an option to the user to view a professional athlete's contract visually that also includes points within the contract history which impacted the trajectory of the professional athlete's contract, and users can see the event as well as impact to the current contract.
